(19) United States
(12) Patent Application Publication
(10) Pub. No.: US 2020/0101822 A1
(43) Pub. Date: Apr. 2, 2020

(54) Structural Reinforcement for Vehicle Door

(71) Applicant: Zephyros, Inc., Romeo, MI (US)

(72) Inventor: Karthick Kandra, Romeo, MI (US)

(21) Appl. No.: 16/587,831

(22) Filed: Sep. 30, 2019

Related U.S. Application Data
(60) Provisional application No. 62/738,372, filed on Sep. 28, 2018.

(51) Int. Cl. B60J 5/04; B60R 1/06

(52) U.S. Cl. CPC B60J 5/0404; B60J 5/0436; B60J 10/80; B60J 5/0454; B60R 1/06; B60J 5/048

(57) ABSTRACT

There is disclosed a member for baffling, reinforcement or sealing. Typically, the member includes a carrier member and an activatable material disposed upon the carrier member.

### FIELD

The present teachings relate generally to a member for providing sealing, baffling, reinforcement or a combination thereof to a transportation vehicle.

### BACKGROUND

Industry, specifically the automotive industry, is constantly seeking new or improved members, materials, and methods of providing baffling, sealing, structural reinforcement or a combination thereof to articles of manufacture such as transportation vehicles. Examples of members designed to provide baffling, sealing, structural reinforcement or a combination thereof to transportation vehicles may be found in U.S. Pat. Nos. 5,755,486; 4,901,500; and 4,751,249; and U.S. Patent Application Publication No. 2007/0080559 A1; which are incorporated by reference herein for all purposes.

The design of members providing baffling, sealing, structural reinforcement or a combination thereof poses challenges. For instance, baffling, sealing, structural reinforcement or a combination thereof may be desired in portions of transportation vehicles that have restricted volume or intricate profiles. Furthermore, members may deployed on certain portions of a transportation vehicle subject to a variety of forces and can cause a variety of undesirable vibrations, noises, or both during operation. Specifically, side mirrors of transportation vehicles extend cantilever from the vehicle and may act in similar fashion to a spring when subject to vibratory forces. This action may distort an image in the mirror, which poses safety concerns and may be undesirable to vehicle owners.

The present invention provides a member that addresses one of the aforementioned problems or difficulties or addresses other problems or difficulties as will become apparent from the following disclosure.

### SUMMARY

The present teachings provide for a closure assembly of a vehicle, the closure assembly comprising: a closure panel of the vehicle including one or more structural walls; a reinforcement member disposed on the one or more structural walls, the reinforcement member including: a base portion; an activatable material disposed on a front face of the reinforcement member; wherein the base portion includes a mounting structure, the mounting structure having attaching means corresponding to complimentary attachments of a cantilever member.

### BRIEF DESCRIPTION

The features and inventive aspects of the present invention will become more apparent upon reading the following detailed description, claims, and drawings, of which the following is a brief description:

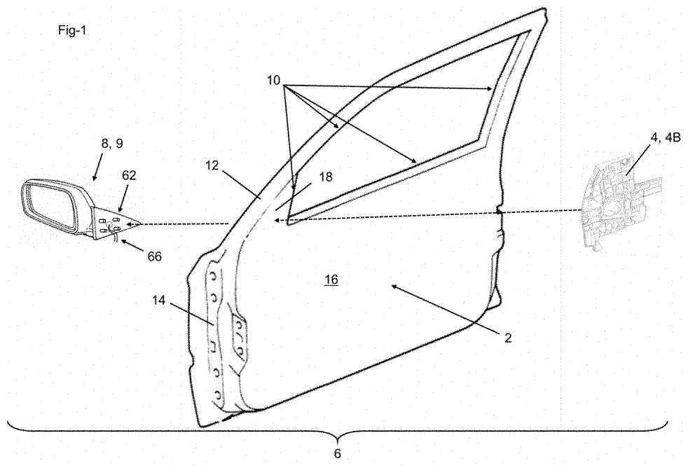

FIG. 1 illustrates an exploded view of a closure assembly.

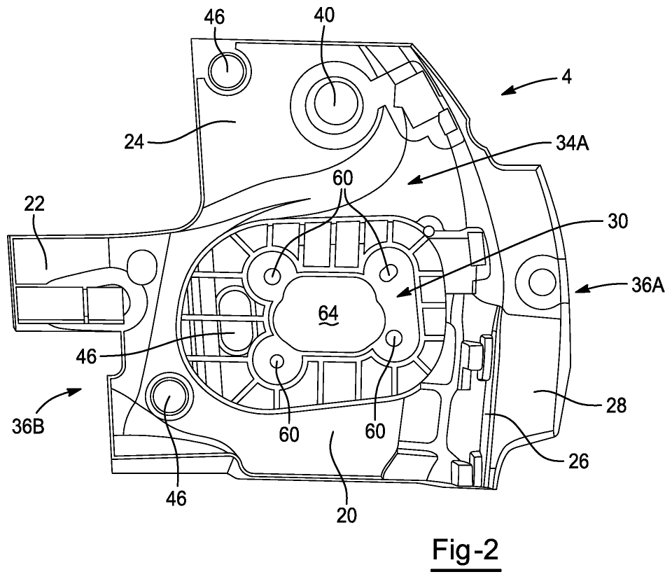

FIG. 2 illustrates a perspective view of the front face of a reinforcement member.

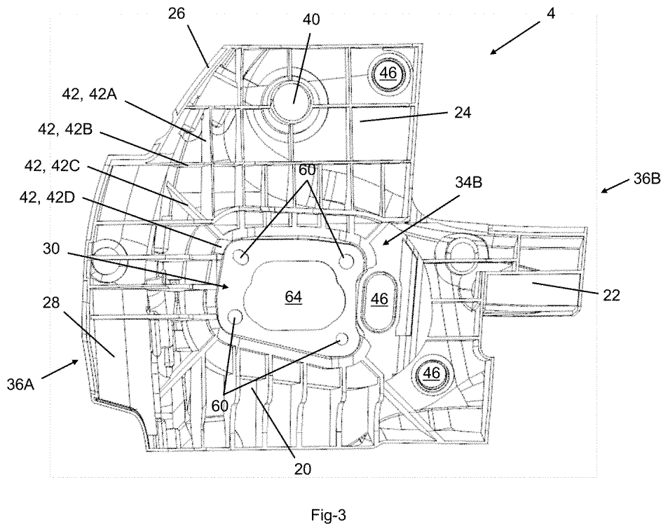

FIG. 3 illustrates a perspective view of the rear face of a reinforcement member.

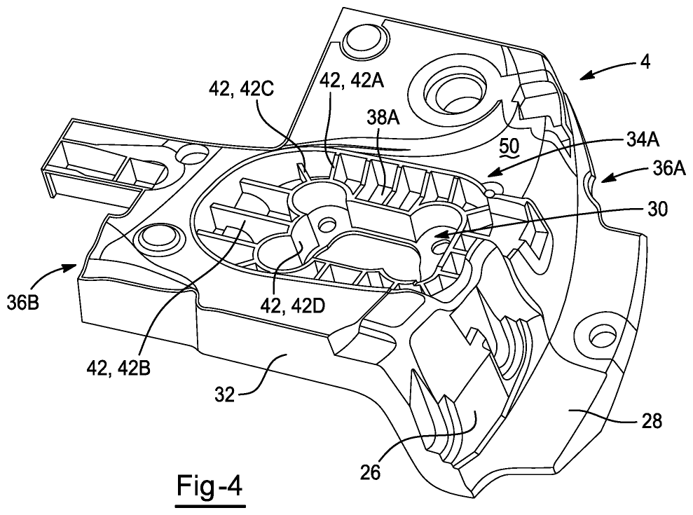

FIG. 4 illustrates an offset perspective view of the front face of a reinforcement member.

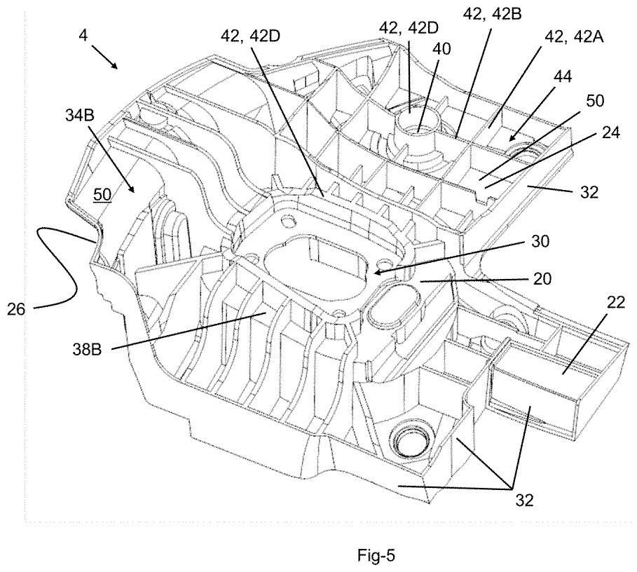

FIG. 5 illustrates an offset perspective view of the rear face of a reinforcement member.

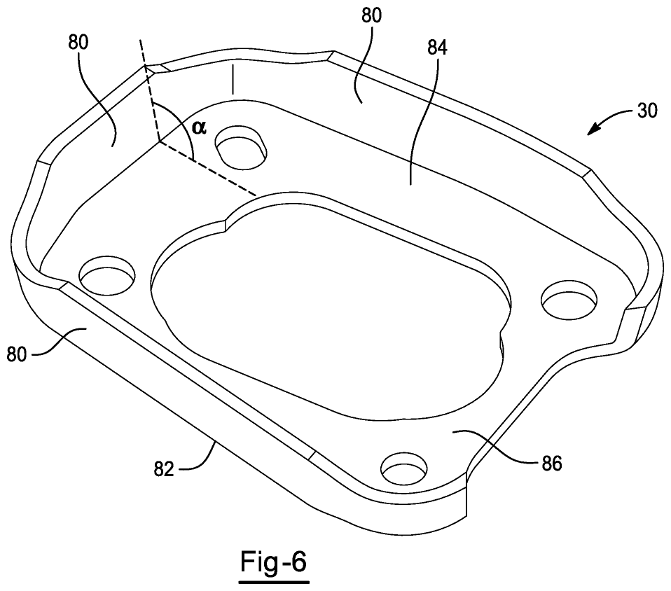

FIG. 6 illustrates a perspective view of a mounting structure.

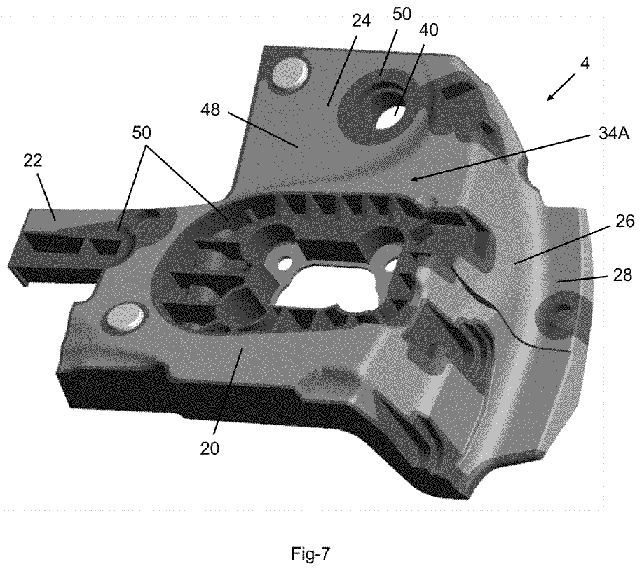

FIG. 7 illustrates an offset perspective view of a reinforcement member including an activatable material.

Persons skilled in the art will appreciate that elements in the figures are illustrated for simplicity and clarity and may have not been drawn to scale. For example, the dimensions of some of the elements in the figure may be exaggerated relative to other elements to help to improve understanding of various exemplary embodiments of the present disclosure. Throughout the drawings, it should be noted that like reference numbers are used to depict the same or similar elements, features, and structures.

### DETAILED DESCRIPTION

The present teachings meet one or more of the above needs by the improved devices and methods described herein. The explanations and illustrations presented herein are intended to acquaint others skilled in the art with the teachings, its principles, and its practical application. Those skilled in the art may adapt and apply the teachings in its numerous forms, as may be best suited to the requirements of a particular use. Accordingly, the specific embodiments of the present teachings as set forth are not intended as being exhaustive or limiting of the teachings. The scope of the teachings should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

This application claims the benefit of the filing date of U.S. Provisional Application Ser. No. 62/738,372, filed Sep. 28, 2019, the contents of that application being hereby incorporated by reference herein for all purposes.

The present disclosure is predicated upon the provision of a member suitable for providing sealing, baffling (i.e., noise reduction), reinforcement (i.e., strength), or a combination thereof to one or more structures of an article of manufacture. Together, the one or more structures and the member can form a system or assembly that is generally desirable for the article of manufacture because of the functional attributes (e.g., noise reduction, sealing, strength, combinations thereof or the like) provided by the member. It is contemplated that the member may be employed in conjunction with a variety of structures of various articles of manufacture such as boats, trains, buildings, appliances, homes, furniture or the like. It has been found, however, that the reinforcement member may be particularly suitable for application to structures or assemblies of transportation vehicles (e.g., cars, SUVs, trucks, bus, vans, and the like). Generally, it is contemplated that the reinforcement member may be applied to various structures such as components of a body, a frame, an engine, a hood, a door, a trunk, a bumper, combinations thereof or the like of a passenger vehicle. Particularly, the reinforcement member may be applied to a closure panel (e.g., side door). Even more particularly, the reinforcement member may be applied to a portion of a door having a cantilever member attached (e.g., side mirror assembly).

The cantilever member may function to extend from the vehicle and provide some utility or function for the vehicle. For example, the cantilever member may be a side mirror assembly, which provides a driver of the vehicle the ability to see objects to the rear of the vehicle. The cantilever member may be acted upon by a number of forces during the life of the vehicle. The cantilever member may exhibit a spring-like behavior (e.g., oscillating about a fulcrum, where the fulcrum is the point at which the cantilever member is attached to the vehicle) as an effect of the forces exerted upon it. For example, vibrations incurred on the vehicle while driving may travel to the cantilever member and may cause the cantilever member to oscillate in a substantially vertical plane (vertical to the ground). As another example, the forceful opening or closing of the closure panel may cause the cantilever member to oscillate along a plane through which the closure panel rotates. As yet another example, the cantilever member may resist air, while the vehicle is in motion, and the air may exert a force upon the cantilever member. Further, the three dimensional shape of the cantilever member may give rise to air currents exerting different pressures on the upper and lower sides of the cantilever member—a positive pressure differential on the upper side causing the cantilever member to exhibit a downward force and a positive pressure differential on the lower side causing the cantilever member to exhibit an upward force. It may further be appreciated by one of reasonable skill in the art that closure panels may be subject to a degree of deformation as a result of said forces exerted on the cantilever member—said deformation may result in unwanted noise, fatigue of the closure panel's structural integrity, or both. Advantageously, the reinforcement member of the present disclosure may prevent unwanted noise or fatigue of the closure panel's structural integrity by bracing against the deformation of the closure panel. The cantilever member may include several sub-components. Where the cantilever member is a side mirror assembly, the side mirror assembly may include complimentary attachments and wires. The complimentary attachments may be attachments that form a complimentary fit with the closure assembly, the reinforcement member, or both. The complimentary attachments may be bolts, integrally attached to the cantilever member, which compliment cantilever openings in the reinforcement member. The wires may power certain functions provided by the side mirror assembly (i.e., illumination, lane change sensors, indicator lights, the like, or a combination thereof). The wires may transport power between the vehicle battery and the side mirror assembly; as such, the wires may extend from the side mirror assembly, pass through the closure panel, and run through the vehicle to the vehicle battery.

The closure panel may function to selectively enclose the cabin of a transportation vehicle. The closure panel may be a side door or a hatch door. The closure panel may include features such as a window frame, an A-pillar edge, a hinged edge, one or more structural walls, a pocket, or a combination thereof. The closure panel may be configured to accept a cantilever member. Particularly, the closure panel may be configured to accept a cantilever member in or immediately adjacent to a pocket, which is a portion of the closure panel framed by the window frame, the A-pillar edge, the hinged edge, one or more structural walls, or a combination thereof. It may be appreciated that the pocket does not provide an abundance of space within which to locate a reinforcement member. Thus, the reinforcement member of the present disclosure may be particularly shaped to fit within the pocket while providing enough strength to the closure panel to preclude deformation of the closure panel. The closure panel may be formed out of sheet metal or polymer. The window frame, the A-pillar edge, the hinged edge, the one or more structural walls, or a combination thereof may be formed of the same piece of sheet metal or polymer. As referred to herein, “closure assembly” comprises the cantilever member, the closure panel, and the reinforcement member in an assembled state.

The A-pillar edge may be the edge of the closure panel that, when in a closed position, sits adjacent the A-pillar (i.e., the front-most pillar of the vehicle supporting the roof of the vehicle).

The hinged edge may be the edge of the closure panel bearing hinges that form a rotatable connection to the body of the vehicle. The hinged edge may be on the same edge of the closure panel as the A-pillar edge.

The window frame may by a void in the closure panel, which is configured to accept a panel of glass. The window frame may be defined by a void in the closure panel having three (3) or more sides, four (4) or more sides, or even five (5) or more sides.

The one or more structured walls may be the walls of the closure panels defining the barrier between the exterior surface of the closure panel (i.e., the exterior surface of the vehicle) and the interior surface of the closure panel (i.e., oriented toward the interior of the cabin). The one or more structured walls may be a structure, within which or by which the window frame, the A-pillar edge, the hinged edge, or a combination thereof, are defined.

The reinforcement member may function to provide baffling, sealing, reinforcement, or a combination thereof to an article of manufacture. Furthermore, the reinforcement member may function as a fixed attachment point for a cantilever member. Furthermore, the reinforcement member may function as a carrier for an activatable material, to position the activatable material within the closure panel to be cured. The reinforcement member may be accepted by (e.g., form a complimentary fit with) the pocket. The reinforcement member may extend into portions of the closure panel adjacent to the pocket. The reinforcement member may form a substantially flush fit with the closure panel and the features of the closure panel. The reinforcement member may be configured to align with and accept a side mirror assembly, which couples to the closure panel on the opposing side of the one or more structured walls to the reinforcement member. More specifically, the reinforcement member and the side mirror assembly may sandwich the one or more structured walls when the closure assembly is in an assembled state. The reinforcement member may be employed to reinforce a structure against a variety of forces which may be exerted by a variety of sources such as forces provided by a vehicle impacts with another object, forces and vibrations caused by terrain conditions across which a vehicle may be traveling, forces exerted by wind resistance, the like, or a combination thereof. The reinforcement member may exhibit a handedness (i.e., configured for use on either the right or left closure assembly of the vehicle). The reinforcement member may include an activatable material, a base portion, a lateral extension, a vertical extension, a profiled portion, a flange, a mounting structure, at least one opening, a peripheral rib, a front face, a rear face, an aft end, a fore end, a surface, at least one opening, ribs, or a combination thereof.

The reinforcement member may be integrally molded or formed of a single material. The material of the reinforcement member may be different from the activatable material. Suitable materials may include for example, and without limitation, metal or a polymeric material (e.g., nylon, polyamide, polyester, polypropylene, polyethylene, molding compound or others) which may be filled or unfilled (e.g., filled with glass or Kevlar® reinforcement fibers). Preferably the reinforcement member is constructed from glass-filled nylon. The glass-filled nylon may comprise 15% glass or more, 25% glass or more, 35% glass or more, or even 45% glass or more. The thickness of the reinforcement member (i.e., the amount of material between the front face and the rear face) may be 2 mm or more, 3 mm or more, or even 4 mm or more.

Depending upon the material used for the reinforcement member, several different forming techniques may be employed to shape the reinforcement member. For example, stamping, extrusion, molding or other techniques may be used. As such, the attachments (discussed infra), when present, can be formed or integrated with the reinforcement member in several different ways as well. As one example, the attachments may be integrally molded or otherwise formed of the same or a different material than the carrier member. Specifically, it is contemplated that the attachments be placed in a mold of a molding machine (e.g., an injection molding machine) and the material of the reinforcement member can be molded to shape while also encasing the portion (e.g., the peripheral edge) of the attachments.

The aft end and fore end of the reinforcement member correspond to the rear end of the vehicle (i.e., where the trunk is located) and the front end of the vehicle (i.e., where the engine bay is located), respectively. The aft end of the reinforcement member may be adjacent the window frame. The fore end of the reinforcement member may be adjacent the A-pillar edge, the hinged edge, or both. The aft end may include a lateral extension. The fore end may include a profiled portion, a flange, or both.

The front face may be oriented toward the closure panel when the reinforcement member is assembled to the closure panel. The front face may be seated substantially flush to the closure panel. The rear face may be oriented away from the closure panel (i.e., toward the interior of a vehicle cabin) on an opposing side of the reinforcement member from the front face.

The base portion may provide a central support structure (i.e., mounting structure) to which a cantilever member may attach. The base portion may further provide a central attachment point for the lateral extension and vertical extension. The base portion may include a mounting structure. Accordingly, the base portion may provide the integral structure to the reinforcement member.

The mounting structure may function as the direct attachment point for the cantilever member. The mounting structure may be a metal plate in the reinforcement member. The mounting structure may be integrally molded within the reinforcement member or otherwise affixed to the reinforcement member. The mounting structure may be located anywhere on the mounting structure but preferably the mounting structure is located on the base portion of the reinforcing member. Particularly, the mounting structure may be located in a depression or boss formed in the surface of the base portion. Preferably, the mounting structure is located in a depression formed in the front surface of the reinforcement member, whereby the mounting structure is offset from the one or more structural walls of the closure panel. The mounting structure may include a void and cantilever openings. The void may be present to allow components, such as wires to pass through. The cantilever openings may be openings that accept complimentary attachments located on the cantilever member. For example, the complimentary attachments may be bolts. It may be appreciated by one of reasonable skill in the art that the cantilever openings may exhibit different shape, size, spacing, layout, or a combination thereof dependent on the shape, size, spacing, layout, or a combination thereof of the complimentary attachments; features that may vary between different vehicle models. The mounting structure may further include a planar structure, having a front and a back, and a protrusion. The planar structure may contain the void and cantilever openings. The front of the planar structure may be oriented in the same direction as the front face of the reinforcement member. The back of the planar structure may be oriented in the same direction as the rear face of the reinforcement member. The protrusion may be a portion of the mounting structure that is bent away from the planar structure and extending toward the back of the planar structure. The protrusion may be bent to an angle from the planar structure. The angle may be no more than 150 degrees and no less than 30 degrees from the planar structure.

The lateral extension, vertical extension, profiled portion, flange, or a combination thereof may function to fit in non-uniform spaces of the closure panel and provide additional support to a reinforcement member. The lateral extension, vertical extension, profiled portion, flange, or a combination thereof may be specifically contoured to components of the closure panel (i.e., window frame, A-pillar edge, hinged edge, or one or more structural walls). It may be understood that the specific shapes disclosed herein may vary in accordance with the structure of the vehicle to which the reinforcement member may be configured to fit. The lateral extension may extend linearly from the aft end of the reinforcement member, from the base portion. The lateral extension may be configured to extend along and fit substantially flush to the bottom edge of a window frame. The vertical extension may extend upward, from the base portion. The vertical extension may be configured to fit substantially flush to both the vertical edge of a window frame and an A-pillar edge. The profiled portion may extend from the fore end of the reinforcement member. The profiled portion may be configured to fit substantially flush to the A-pillar edge, the hinged edge, or both. The profiled portion may exhibit a profile or curvature configured to form a complimentary fit to the profile or curvature of the A-pillar edge, the hinged edge, or both. Accordingly, the profile or curvature of the profiled portion may be oriented away from (curve away from) the one or more structural walls, inward toward the interior of the cabin of a vehicle. The flange may be attached to the profiled portion, on a terminal end of the profiled portion. The flange may curve around the A-pillar edge, the hinged edge, or both, the curvature of which is oriented away from the interior of the cabin of a vehicle. The flange may have a substantially flush fit to the A-pillar edge, the hinged edge, or both. The flange may extend in a plane that is substantially parallel to the plane through which the base portion extends.

The surface of the reinforcement member may be defined by the continuous shell of the reinforcement member defining the base portion, the lateral extension, vertical extension, profiled portion, and flange (not including the ribs). The surface may or may not include an activatable material dispensed thereon. A portion of the surface may include an activatable material while another portion of the surface may not have an activatable material dispensed thereon. The surface of the reinforcement member may further include the portion of the reinforcement member defining the at least one opening. Ribs may extend from the surface, on either or both the front face or rear face. The surface may include a depression or boss. It may be appreciated by one of skill in the art that where a depression is formed in a front face of the reinforcement member a boss is located on the rear face, and vice versa.

The ribs may function to provide torsional and flexional strength to the reinforcement member. The reinforcement member may include ribs although not required. The ribs may be located on the front face, the rear face, or both. The ribs may extend, perpendicularly, from the surface of the reinforcement member; the ribs may extend from the front face, the rear face, or both. The ribs may include longitudinal ribs, latitudinal ribs, angled ribs, profiled ribs, peripheral ribs, or a combination thereof. Intersecting ribs may define a cavity, which may be a space where the volume is defined by ribs and the surface of the reinforcement member.

The latitudinal ribs may extend from the fore end to the aft end of the reinforcement member. The longitudinal ribs may extend perpendicular to the latitudinal ribs. The angled ribs may extend at any angle not coincident with the angles of the longitudinal ribs (e.g., “vertical”) or the latitudinal ribs (e.g., “horizontal”). The profiled ribs contour the profile of features of the reinforcement member such as the mounting structure or the at least one opening. The peripheral rib may frame the profile of the reinforcement member and extend from the distal edge of the reinforcement member. The thickness of the ribs (i.e., the amount of material between the front face and the rear face of the reinforcement member) may be 2 mm or more, 3 mm or more, or even 4 mm or more.

The at least one opening may function to accept attachments. The at least one openings may include cavities or through-holes defined in the reinforcing member, the activatable material, or both. The at least one opening may be located on different segments of the reinforcement member (i.e., base portion, lateral extension, vertical extension, profiled portion, flange). The at least one opening may extend fully through the reinforcement member (i.e., from the front face to the rear face of the reinforcement member).

The attachments may function to affix the reinforcement member to the closure panel. The attachments may be per meant or selectively removable. The attachments may be supplied in a variety of configurations such as interference fitting fasteners (e.g., arrowhead or bulb type fasteners or push-pins which may be formed of plastic, Mylar, metal or other materials), adhesive fasteners, magnetic fasteners, weld coins, combinations thereof or the like. As referred to herein, “weld coins” may refer to metal components that are located at least partially within or directly adjacent the at least one opening and that may be welded (e.g., via electrical resistance, heat, vibration or otherwise welded), with a weld gun or other instrument, to the closure panel. The weld coins may comprise aluminum, steel (e.g., G60 galvanized steel), magnesium, iron, combinations thereof, or the like. The weld coins may be substantially planar, circular, disc-shaped, or a combination thereof. The attachments may extend through the at least one opening, extending from the front face of the reinforcement member to the rear face of the reinforcement member. It is additionally contemplated that the attachments may be removed such that its corresponding at least one opening could remain open as a clearance hole or other opening (e.g., for accommodating and/or receiving components of the article of manufacture).

The activatable material may function to provide baffling, sealing, structural reinforcement, or a combination thereof. The expandable material may span a cavity of a structure for inhibiting passage of sound or matter through that cavity. As used for the present disclosure, the term activatable material is intended to mean a material that can be activated to cure, expand (e.g., foam), soften, flow or a combination thereof. Thus, it is contemplated for the present disclosure that an activatable material may be activated to perform only one of aforementioned actions or any combination of the aforementioned actions unless otherwise stated. In the embodiment illustrated, the activatable material is directly disposed upon and typically adhered to the surface of the reinforcement member and, as shown, the activatable material covers a substantial portion (e.g., at least 40%, 60%, 80% or more) of the surface area of the surface of the reinforcement member.

A variety of activatable materials may be used for the reinforcement member of the present disclosure. The activatable material may be formed of a heat-activated material and may flow, cure (e.g., be thermosettable), foam, or a combination thereof upon exposure to heat. The activatable material may be generally dry to the touch and substantially non-tacky or may be tacky and, in either situation, may be shaped in any form of desired pattern, placement, or thickness, but is preferably of substantially uniform thickness. Exemplary heat-activated activatable materials include L-5200, L-5220, L-7102 and L-7220 foams, commercially available through L&L Products, Inc. Another exemplary activatable material is disclosed in U.S. Pat. No. 7,199,165, incorporated herein by reference for all purposes. Though other heat-activated materials are possible, a preferred heat activated material is an expandable polymer or plastic, and preferably one that is foamable. Particularly preferred materials are an elastomer-based, an epoxy-based, acrylate-based or acetate-based foams, which may be structural, sealing, baffling, acoustic, or a combination thereof. For example, and without limitation, the foam may be an epoxy-based material, including an ethylene copolymer or terpolymer that may possess an alpha-olefin. As a copolymer or terpolymer, the polymer is composed of two or three different monomers, (i.e., small molecules with high chemical reactivity that are capable of linking up with similar molecules).

A number of epoxy-based or otherwise based sealing, baffling or acoustic foams are known in the art and may employed with the present disclosure. A typical foam includes a polymeric base material, such as an epoxy resin or ethylene-based polymer which, when compounded with appropriate ingredients (typically a blowing and curing agent), expands and cures in a reliable and predicable manner upon the application of heat or the occurrence of a particular ambient condition. From a chemical standpoint for a thermally-activated material, the structural foam is usually initially processed as a flowable thermoplastic material before curing. It will cross-link upon curing, which makes the material incapable of further flow.

One advantage of the preferred structural foam materials over prior art materials is that the preferred materials can be processed in several ways. The preferred materials can be processed by injection molding, extrusion, compression molding or with a mini-applicator. This enables the formation and creation of part designs that exceed the capability of most prior art materials.

While preferred materials have been disclosed, other materials may be used as well, particularly materials that are heat-activated or otherwise activated by an ambient condition (e.g., moisture, pressure, time, chemical reaction or the like) and expand, cure, or both in a predictable and reliable manner under appropriate conditions for the selected application. Of course, the material may also be formed of non-activatable materials, non-expandable materials, or otherwise. Thus, upon activation, the material may soften, cure and expand; soften and cure only; cure only; soften only; or may be non-activatable.

One example of an expandable activatable material is the epoxy-based resin disclosed in U.S. Pat. No. 6,131,897, the teachings of which are incorporated herein by reference. Some other possible materials include, but are not limited to, polyolefin materials, copolymers, and terpolymers with at least one monomer type an alpha-olefin, phenol/formaldehyde materials, phenoxy materials, thermoplastic materials, and polyurethane materials. Examples of other possible materials are disclosed in U.S. Pat. Nos. 5,766,719; 5,755,486; 5,575,526; and 5,932,680, the teachings of which are incorporated herein by reference. In general, the desired characteristics of the material can include relatively high glass transition temperature (typically greater than 70° C.), and adhesion durability properties. In this manner, the material does not generally interfere with the materials systems employed by automobile manufacturers.

Other exemplary expandable materials can include combinations of two or more of the following: epoxy resin, polystyrene, styrene butadiene-styrene (SBS) block copolymer, butadiene acrylo-nitrile rubber, amorphous silica, glass microspheres, azodicarbonamide, urea, dicyandiamide. Examples of such materials are sold under the tradename SIKAELASTOMER, SIKAREINFORCER and SIKABAFFLE and are commercially available from the Sika Corporation.

In applications where the material is a heat activated, thermally expanding material, an important consideration involved with the selection and formulation of the material comprising the foam is the temperature at which a material reaction or expansion, and possibly curing, will take place. Typically, the foam becomes reactive or activated at higher processing temperatures, such as those encountered in an automobile assembly plant, when the foam is processed along with the automobile components at the elevated temperatures or at higher applied energy levels, e.g., during paint, primer or e-coat baking or curing steps. While temperatures encountered in an automobile assembly operation may be in the range of about 147° C. to 205° C., body and paint shop applications are commonly about 93° C. or higher. If needed, blowing agent activators can be incorporated into the composition to cause expansion at different temperatures outside the above ranges. Generally, suitable expandable foams have a volumetric range of expansion ranging from approximately 0 to over 1000 percent (e.g., volumetric expansion of greater than 50%, 100%, 200% or 500% of the original unexpanded volume of the material).

The material or medium may be at least partially coated with an active polymer having damping characteristics or other heat activated polymer, (e.g., a formable hot melt adhesive based polymer or an expandable structural foam, examples of which include olefinic polymers, vinyl polymers, thermoplastic rubber-containing polymers, epoxies, urethanes or the like) placed along the mold through the use of baffle technology; a die-cast application according to teachings that are well known in the art; pumpable application systems which could include the use of a baffle and bladder system; and sprayable applications.

The activatable material, as discussed, can also be processed in multiple different ways. As such, the activatable material may be applied to the reinforcement member using a variety of techniques for forming the member. For example, the reinforcement member is placed as an insert into a mold of an injection molding machine and the activatable material is insert injection molded into place such that it adheres to the reinforcement member. As another example, the member is formed by two shot injection molding wherein injection of a first shot of material forms the reinforcement member and injection molding a second shot of material forms, applies, or a combination thereof, the activatable material and positions the activatable material relative to the surface of the reinforcement member. It is also contemplated that the attachments may be molded in place or otherwise integrated with the activatable material.

Application

A reinforcement member according to the present disclosure may be applied to a variety of locations upon a variety of articles of manufacture. Generally, a reinforcement member in accordance with the present disclosure is quite suitable for application to a structure defining a pocket. In such a circumstance, the reinforcement member can be located within the pocket of the structure for providing sealing, baffling or reinforcement to the structure.

The attachments of the present invention, when used, may be employed to at least temporarily attach the member to a structure and such attachment will depend upon the structure to which the member is applied and/or the type of attachment used. For example, many interference fit type attachments will include a portion (e.g., a larger or bulbous portion or an arrow shaped tip portion), which can be inserted into an opening (e.g., through-hole) of a structure such that the attachment attaches to the structure for at least temporarily attaching the member in a cavity of the structure.

FIG. 1 illustrates a closure assembly 6 including a cantilever member 8, which is a side mirror assembly 9. The closure assembly 6 includes a reinforcement member 4, which is a right reinforcement member 4B, and a closure panel 2. The closure panel 2 includes a window frame 10, an A-pillar edge 12, a hinged edge 14, one or more structural walls 16, and a pocket 18. The pocket 18 is defined by a side of the window frame 10, an A-pillar edge 12, and one or more structural walls 16. One of the one or more structural walls 16 is located between the A-pillar edge 12 and the window frame 10. The side mirror assembly 9 includes complimentary attachments 62 and wires 66. The side mirror assembly 9, one of the one or more structural walls 16, and the reinforcing member 4 align upon assembly.

FIG. 2 illustrates a front face 34A of a reinforcement member 4. The reinforcement member 4 includes a base portion 20, a lateral extension 22, a vertical extension 24, a profiled portion 26, and a flange 28. The lateral extension 22 extends from the base portion 20, toward the aft end 36B of the reinforcement member 4. The vertical extension 24 extends upward from the base portion 20. The profiled portion 26 is located on a fore end 36A of the reinforcement member 4 and exhibits a curvature that is configured to substantially correspond with the A-pillar edge (not shown). A flange 28 extends from the profiled portion 26. The reinforcement member 4 includes three of the one or more attachments 46. One attachment 46 is located on the vertical extension 24 and two attachments 46 are located on the base portion 20. The base portion 20 further includes a mounting structure 30. The mounting structure 30 comprises a void 64 and attaching means 60. The attaching means 60 are configured to accept complimentary attachments (not shown) of a side mirror assembly (not shown). The reinforcement member 4 further includes one of at least one opening 40, which is located on the vertical extension 24.

FIG. 3 illustrates a rear face 34B of a reinforcement member 4. The reinforcement member 4 includes a base portion 20, a lateral extension 22, a vertical extension 24, a profiled portion 26, and a flange 28. The lateral extension 22 extends from the base portion 20, to the aft end 36B of the reinforcement member 4. The vertical extension 24 extends upward from the base portion 20. The profiled portion 26 is located on a fore end 36A of the reinforcement member 4 and exhibits a curvature that is configured to substantially correspond with the A-pillar edge (not shown). A flange 28 extends from the profiled portion 26. The reinforcement member 4 includes three of the one or more attachments 46. One attachment 46 is located on the vertical extension 24 and two attachments 46 are located on the base portion 20. The base portion 20 further includes a mounting structure 30. The mounting structure 30 comprises a void 64 and attaching means 60. The attaching means 60 are configured to accept complimentary attachments (not shown) of a side mirror assembly (not shown). The reinforcement member 4 further includes one of at least one opening 40, which is located on the vertical extension 24 of the reinforcement member 4. The rear face 34B further comprises ribs 42 including longitudinal ribs 42A, latitudinal ribs 42B, angled ribs 42C, and profiled ribs 42D.

FIG. 4 illustrates a front face 34A of a reinforcement member 4. The reinforcement member 4 includes a profiled portion 26, which curves away from the front face 34A and to which the flange 28 is attached. The reinforcement member 4 further includes a mounting structure 30 located within a depression 38A of a surface 50. Surrounding and supporting the mounting structure 30, are ribs 42. The ribs 42 extend perpendicular from the surface 50 of the front face 34A. The ribs 42 include longitudinal ribs 42A, latitudinal ribs 42B, angled ribs 42C, and profiled ribs 42D. The latitudinal ribs 42B run from the fore end 36A to the aft end 36B of the reinforcement member 4. The longitudinal ribs 42A run perpendicular to the latitudinal ribs 42A. The angled ribs 42C run at an angle with respect to both the longitudinal ribs 42A and the latitudinal ribs 42B. The profiled ribs 42D contour the profile of the mounting structure 30. The reinforcement member 4 includes a peripheral rib 32 extending perpendicular from the surface of the front face 34A toward the rear face (not shown).

FIG. 5 illustrates a rear face 34B of a reinforcement member 4. The reinforcement member 4 includes a mounting structure 30, located on a boss 38B. The reinforcement member 4 includes ribs 42. The ribs 42 extend perpendicular from the surface 50 of the rear face 34B. The ribs 42 include longitudinal ribs 42A, latitudinal ribs 42B, angled ribs 42C, and profiled ribs 42D. The latitudinal ribs 42B run from the fore end 36A to the aft end 36B of the reinforcement member 4. The longitudinal ribs 42A run perpendicular to the latitudinal ribs 42A. The angled ribs 42C run at an angle. The profiled ribs 42D contour the profile of the mounting structure 30 and the at least one opening 40. The reinforcement member 4 includes a peripheral rib 32 extending perpendicular from the surface of the front face 34A toward the rear face (not shown). The peripheral rib 32 extends around the perimeter of the base portion 20, lateral extension 22, and vertical extension 24, and terminates where the base portion 20 meets the profiled portion 26. The ribs 42, the peripheral rib 32, or both define cavities 44. The reinforcement member further includes at least one opening 40

FIG. 6 illustrates a mounting structure 30. The mounting structure 30 has a front 82 and a back 84. The front 82 is oriented in the same direction as the front face (not shown) of the reinforcement member (not shown). The back 84 is oriented in the same direction as the rear face (not shown) of the reinforcement member (not shown). The mounting structure includes a planar structure 86 and a protrusion 80. The protrusion 80 is a part of the mounting structure 30 that is bent to an angle α from the planar structure 86.

FIG. 7 illustrates a front face 34A of a reinforcement member 4 including an activatable material 48. The reinforcement member 4 has a surface 50. An activatable material 48 is dispensed upon the surface 50 of the reinforcement member 4. The coverage of the activatable material 48 extends across the base portion 20, lateral extension 22, vertical extension 24, profiled portion 26, and flange 28. The activatable material 48 does not cover the entirety of the surface 50 of the reinforcement member, for example the surface 50 immediately adjacent the at least one opening 40.

As used herein, unless otherwise stated, the teachings envision that any substrate of a genus (list) may be excluded from the genus; and/or any substrate of a Markush grouping may be excluded from the grouping.

Unless otherwise stated, any numerical values recited herein include all values from the lower value to the upper value in increments of one unit provided that there is a separation of at least 2 units between any lower value and any higher value. As an example, if it is stated that the amount of a component, a property, or a value of a process variable such as, for example, temperature, pressure, time and the like is, for example, from 1 to 90, preferably from 20 to 80, more preferably from 30 to 70, it is intended that intermediate range values such as (for example, 15 to 85, 22 to 68, 43 to 51, 30 to 32 etc.) are within the teachings of this specification. Likewise, individual intermediate values are also within the present teachings. For values which are less than one, one unit is considered to be 0.0001, 0.001, 0.01, or 0.1 as appropriate. These are only examples of what is specifically intended and all possible combinations of numerical values between the lowest value and the highest value enumerated are to be considered to be expressly stated in this application in a similar manner. As can be seen, the teaching of amounts expressed as “parts by weight” herein also contemplates the same ranges expressed in terms of percent by weight. Thus, an expression in the of a range in terms of “at least ‘x’ parts by weight of the resulting composition” also contemplates a teaching of ranges of same recited amount of “x” in percent by weight of the resulting composition.”

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

The disclosures of all articles and references, including patent applications and publications, are incorporated by reference for ail purposes. The term “consisting essentially of to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist of, or consist essentially of the elements, ingredients, components or steps.

Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

It is understood that the above description is intended to be illustrative and not restrictive. Many embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventors did not consider such subject matter to be part of the disclosed inventive subject matter.

We claim:

1. A reinforcement member for use with a closure panel of a vehicle, the reinforcement member comprising:
a. a base portion configured to fit within a pocket of and substantially flush to the closure panel;
b. an activatable material disposed on a front face of the reinforcement member;
wherein the base portion includes a mounting structure, the mounting structure having attaching means corresponding to complimentary attachments of a cantilever member.

2. The reinforcement member of claim 1, wherein the cantilever member is a side mirror assembly.

3. The reinforcement member of claim 1, wherein during use of the vehicle, the reinforcement member reinforces the cantilever member against one or more forces applied by air resistance.

4. The reinforcement member of claim 2, wherein during use of the vehicle, the reinforcement member reinforces the cantilever member against one or more forces applied by vibrations of the vehicle resulting from road conditions.

5. The reinforcement member of claim 1, wherein the reinforcement member includes a vertical extension extending upward from the base portion, into a portion of the closure panel between an A-pillar edge of the closure panel and a window frame of the closure panel.

6. The reinforcement member of claim 3, wherein the reinforcement member includes a lateral extension extending linearly from an aft end of the reinforcement member from the base portion, fitting substantially flush to a bottom of a window frame of the closure panel.

7. The reinforcement member of claim 4, wherein the reinforcement member includes a profiled portion that is configure to fit substantially flush against an A-pillar edge of the closure panel, a hinged edge of the closure panel, or a combination thereof.

8. The reinforcement member of claim 2, wherein the reinforcement member includes ribs, extending perpendicular to a surface of the reinforcement member.

9. The reinforcement member of claim 4, wherein the reinforcement member includes at least one opening configured to accept at least one attachment.

10. The reinforcement member of claim 1, wherein the mounting structure is a steel plate affixed within the reinforcement member.

11. The reinforcement member of claim 1, wherein the mounting structure includes a void configured to allow wires of a side mirror assembly to pass through.

12. The reinforcement member of claim 1, wherein the mounting structure is framed by ribs.

13. The reinforcement member of claim 12, wherein the ribs include profiled ribs, which are disposed around a curved profile of the mounting structure, the curved profile being defined by the distal edges of a void and attaching means; wherein the profiled ribs are disposed, offset from both the void and attaching means, and the distal end of the mounting structure.

14. The reinforcement member of claim 9, wherein the reinforcement member further comprises an activatable material, wherein the activatable material is located on a front face of the reinforcement member, the front face being oriented toward the closure panel upon assembly.

15. The reinforcement member of claim 14, wherein the activatable material exhibits foaming characteristics.

16. The reinforcement member of claim 1, wherein the activatable material is a thermosettable foam

17. The reinforcement member of claim 1, wherein the reinforcement member is affixed in a pocket; wherein the pocket is defined by the area between a window frame of the closure panel, an A-pillar edge of the closure panel, and one or more structural walls of the closure panel.

18. The reinforcement member of claim 17, wherein the reinforcement member extends to areas of the closure panel immediately adjacent to the pocket.

19. The reinforcement member of claim 1, wherein an attachment is disposed immediately adjacent to the mounting structure.

20. The reinforcement member of claim 1, wherein the mounting structure is located in a depression formed in the front face of the reinforcement member.
